(19) United States
(12) Patent Application Publication
(10) Pub. No.: US 2016/0260276 A1
(43) Pub. Date: Sep. 8, 2016

(54) COIN PROCESSING DEVICE

(71) Applicant: NIPPON CONLUX CO., LTD., Sakado-shi, Saitama (JP)

(72) Inventors: Jun YAMADA, Sakado-shi (JP); Yasuyuki KIMURA, Sakado-shi (JP); Masaaki TOKINIWA, Sakado-shi (JP)

(73) Assignee: NIPPON CONLUX CO., LTD., Sakado-shi, Saitama (JP)

(21) Appl. No.: 15/029,681

(22) PCT Filed: Sep. 30, 2014
(86) PCT No.: PCT/JP2014/076116

§ 371 Date: Apr. 15, 2016

(30) Foreign Application Priority Data
Oct. 18, 2013 (JP) 2013-217357

(51) Int. Cl. G07D 5/08

(52) U.S. Cl. CPC G07D 5/08

(57) ABSTRACT

The present invention has the purpose of providing a coin processing device capable of identifying a plated coin with high precision. An identification sensor 3 is arranged on a wall face of a coin passage 2 in which the coin 1 rotatively moves, in a position where a thickly plated part of layer of the coin 1 passes through, and genuineness of the coin is determined by obtaining from output of the identification sensor 3 data including characteristics of both of a plated layer and a core material of the coin 1.

### TECHNICAL FIELD

The present invention relates to a coin processing device, in particular to a coin processing device for identifying plated coins.

### BACKGROUND ART

Recently, more and more plated foreign coins have been used. The plated coins include coins obtained by performing nickel plating on iron, for example, and wear resistance and corrosion resistance of the coins are improved. Therefore, as shown in FIG. 1 (b) which is a cross section figure of the straight line X-X′ in the drawing of the coin 501 shown in FIG. 1 (a), the coin 501 is constituted by two materials, namely iron 502 and nickel 503.

When denomination or genuineness of the coin 501 is identified in a conventional coin processing device as shown in FIG. 2, for example, an identification sensor 505 and an identification sensor 506 are arranged in a coin passage 504 inclined so that the coin 501 rotatively moves in the direction of the arrow Y in the drawing, and the identification sensor 505 identifies a core material of the coin and the identification sensor 506 identifies a plated material of the coin surface layer.

The identification sensors 505, 506 are both coils connected to an oscillation circuit, and the identification sensor 505 is oscillated at relatively low frequency (40 kHz, for example) and the identification sensor 506 is oscillated at relatively high frequency (500 kHz, for example), thereby can identify the core material and the plated material of the coin respectively.

It is noted that a method for identifying a coin constituted by two different materials is described in the Patent document 1, for example.

### PRIOR ART DOCUMENT

### Patent Document

Patent document 1: Japanese Patent No. 4126668

### SUMMARY OF INVENTION

### Problems to be Solved by the Invention

However, the plating on the coin surface layer of the plated coin is about several μm to several tens μm thick, being sometimes inconsistent, and thus, it was difficult to grasp the characteristics of the plated coin with high accuracy. Accordingly, genuine plated coins and forged plated coins could not always be distinguished with high accuracy.

Accordingly, the present invention has the purpose of providing the coin processing device capable of identifying a plated coin with high accuracy.

### Means to Solve the Problem

In order to achieve the above purpose, the invention in claim 1 is characterized with a coin identification device which identifies a plated coin characterized by comprising an identification sensor formed of coils arranged on a wall face of a coin passage in which the coin rotatively moves, in a position where a thickly plated part of layer of the coin passes through, and determination means for determining coin genuineness by obtaining from output of the identification sensor characteristic data including characteristics of both of a plated layer and a core material of the coin.

Also, the invention in claim 2 is characterized, in the invention in claim 1, in that the identification sensor is arranged on an upper part and a lower part of the wall face of the coin passage.

Also, the invention in claim 3 is characterized, in the invention in claim 2, in that the identification sensor is arc-shaped according to diameter of the coin to be identified.

Also, the invention in claim 4 is characterized, in the invention in claim 1, in that the identification sensor is annularly shaped with circumference according to the diameter of the coin to be identified.

Also, the invention in claim 5 is characterized, in any of the inventions in claims 1-4, in that the identification sensor comprises printed coils obtained by forming a spiral coil of metal foil on a substrate.

### Effect of the Invention

According the present invention, a plated coin can be identified with high precision by making use of its characteristics.

### BRIEF EXPLANATION OF THE DRAWINGS

FIG. 1 explains a plated coin.

FIG. 2 shows an example of conventional coin identification device for identifying a plated coin.

FIG. 3 explains the dog-bone effect.

FIG. 4 shows an example of how the identification sensor in the coin processing device in Embodiment 1 in the present invention is arranged.

FIG. 5 shows a circuit configuration example of the coin processing device in Embodiment 1 in the present invention.

FIG. 6 explains the principle for determining coins in Embodiment 1 in the present invention.

FIG. 7 shows the flow of operation of the coin processing device in Embodiment 1 in the present invention.

FIG. 8 shows an output example of the identification sensor 3 in Embodiment 1 in the present invention.

FIG. 9 shows an example of how the identification sensor in the coin processing device in Embodiment 2 in the present invention is arranged.

FIG. 10 shows a circuit configuration example of the coin processing device in Embodiment 2 in the present invention.

FIG. 11 explains an example in which dust 20, etc. is accumulated on the floor face of the coin passage 2 in Embodiment 2 in the present invention.

FIG. 12 shows an example of how the identification sensor in the coin processing device in Embodiment 3 in the present invention is arranged.

FIG. 13 shows a configuration example of the coin identification sensor 203.

FIG. 14 shows an example of how the identification sensor in the coin processing device in Embodiment 3 in the present invention is arranged.

FIG. 15 shows a configuration example of the coin identification sensor 303.

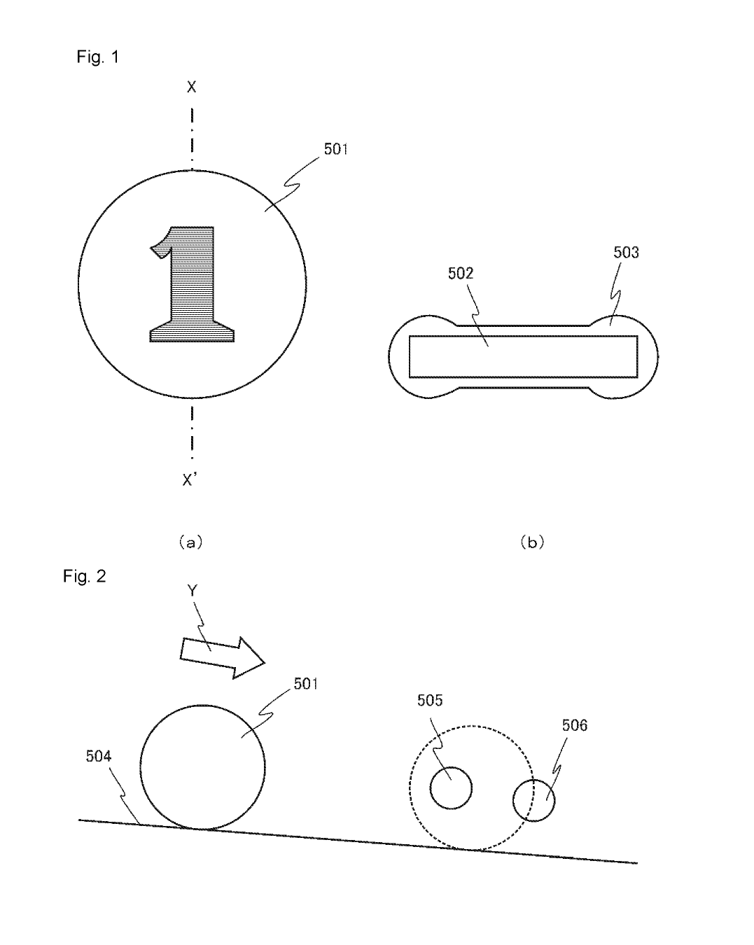

### EMBODIMENTS FOR IMPLEMENTING THE INVENTION

Shown below is the detailed explanation regarding one embodiment of the coin processing device in the present invention referring to the attached drawings.

At first, the summary of the invention is explained. The present invention intends to determine genuineness of coins while paying attention to the dog-bone effect generated when a coin is plated.

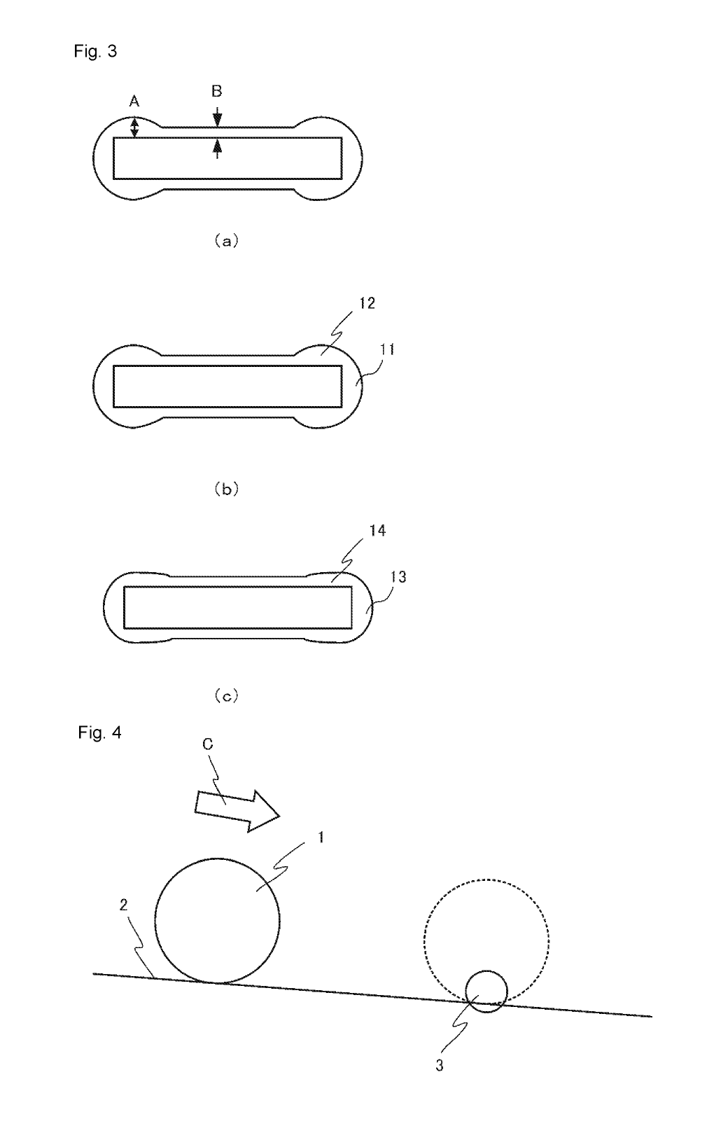

FIG. 3 explains the dog-bone effect. FIG. 3 (a) and FIG. 3 (b) show a genuine coin constituted by a core material 11 and a plated layer 12. FIG. 3 (c) shows a forged coin constituted by a core material 13 and a plated layer 14. Plating by electroplating concentrates electrical field to the edge of the core material making the plated layer in the edge thicker than the other plated area. Thereby, in the plated coin, as shown in FIG. 3 (a), B defined as the thickness of the plated layer around the center of the coin is smaller than A defined as the thickness of the plated layer in the margin of the coin which is the edge of the core material, namely shown as A>B.

Therefore, the plated layer in the margin of the coin, namely the edge of the core material thicker than the plated layer in the center of the coin allows the characteristics of the plate material to be obtained more easily.

Also the investigation of the actual genuine/forged coin has confirmed that, due to the difference of plating effect between a genuine coin and a forged coin, the thickness of the plated layer in the margin of the genuine coin due to the dog-bone effect is different from the thickness of the plated layer in the margin of the forged coin due to the dog-bone effect, as shown in the genuine coin in FIG. 3 (b) and the forged coin in FIG. 3 (c).

In the present invention, the thickness of the plated layer in the margin of the coin is recognized as characteristic, and this characteristics is utilized to determine the genuineness of the coin.

### Embodiment 1

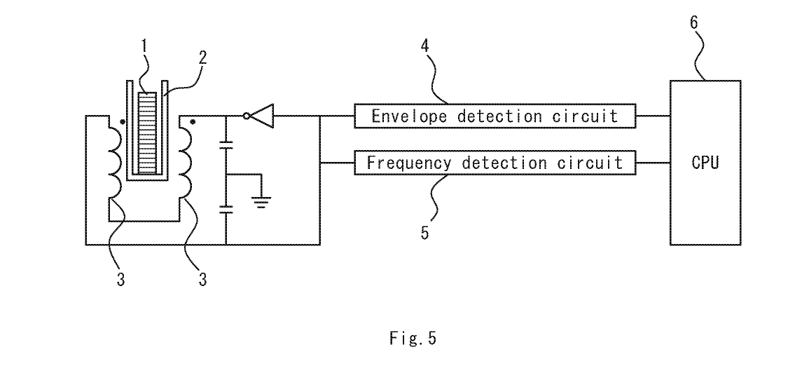

FIG. 4 shows an example of how the identification sensor in the coin processing device in Embodiment 1 in the present invention is arranged. As shown in FIG. 4, in the coin processing device in Embodiment 1, the identification sensor 3 is arranged in the coin passage 2 inclined so that the coin 1 rotatively moves in the direction of the arrow C in the drawing.

This identification sensor 3 is arranged in the lower part in the coin passage 2, where the part of the layer in the coin 1 thickly plated due to the dock-bone effect passes through.

Also, the identification sensor 3 comprises a pair of coils and, as shown in FIG. 5, is connected to an oscillation circuit in series and oscillates at 500 kHz. CPU 6 obtains voltage from the oscillation circuit by way of an envelope detection circuit 4, obtains frequency by way of a frequency detection circuit 5. The CPU 6 functions as determination means, and determines the genuineness of the coin by using determination function to the obtained voltage and frequency.

As a method for determining the genuineness of coins from the obtained voltage value and frequency value by using the determination function, such a method as the method for determination based on whether or not the obtained value of voltage or frequency is included within the range of predetermined threshold value and the method for comprehensive determination based on how similar the obtained values of both of voltage and frequency and the genuine coin data prestored in a memory, etc. are to each other can be used, for example.

It is noted that, for the coils constituting the identification sensor 3, a winding coil obtained by winding copper wire, etc. around a core or a printed coil obtained by spirally printing metal foil on a substrate (formed in the same way as the way a printed substrate is formed) can be used.

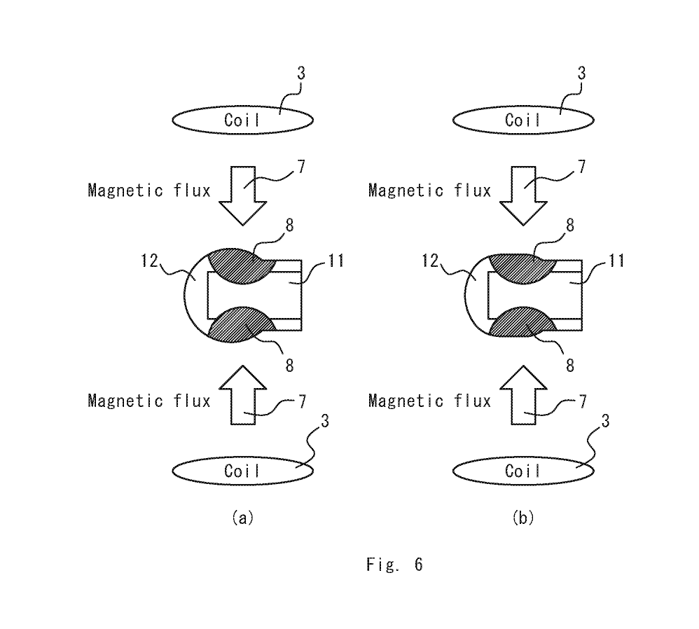

Next, the principle for determining coins based on the difference of the dog-bone effect is explained. FIG. 6 explains the principle for determining coins.

When a coin passes through the vicinity of the identification sensor 3, the magnetic flux 7 generated in the identification sensor (coils) 3 causes eddy current to be generated in the coin, and this eddy current causes the voltage and its frequency output from the identification sensor 3 to be changed.

In this case, as shown in FIG. 6 (a), in the genuine coin (shown in FIG. 3 (b)) constituted by the core material 11 and the plated layer 12, the eddy current generation region is shown by the reference numeral 8.

In contrast, as shown in FIG. 6 (b), in the forged coin (shown in FIG. 3(c)) constituted by the core material 13 and the plated layer 14, since the plated layer 14 in the margin of the forged coin is thinner than the plated layer 12 in the margin of the genuine coin, the magnetic field permeates to the inside of the coin, and the eddy current generation region is shown by the reference numeral 9.

Due to this difference between the eddy current generating region 8 and the eddy current generating region 9, the voltage and its frequency output from the identification sensor 3 change differently in comparison between the case where the genuine coin has passed and the case where the forged coin has passed, and the difference enables the genuine coin and the forged coin to be determined.

It is noted that the characteristic data of the coin composed of the voltage value and frequency value obtained from the coin includes characteristics of both of the plated layer and the core material in the thickly plated part of the layer. Therefore, in the coin processing device in Embodiment 1 in the present invention, the genuineness is determined based on the characteristic data including the characteristics of both of the plated layer and the core material.

Also, the identification sensor 3 is arranged in the thickly plated position of the layer, and the sensor oscillates at relatively high frequency, and thus, the voltage value and frequency value obtained in the coils 3 notably reflect the difference of plated layer thickness between the genuine coin and the forged coin, and thereby the plated coin can be identified with high precision.

It is noted that, regardless of the above explanation that the identification sensor 3 oscillates at 500 kHz, this frequency is not limited as long as it is subject to the characteristics of the coin surface layer, which is the frequency from 200 kHz to 600 kHz.

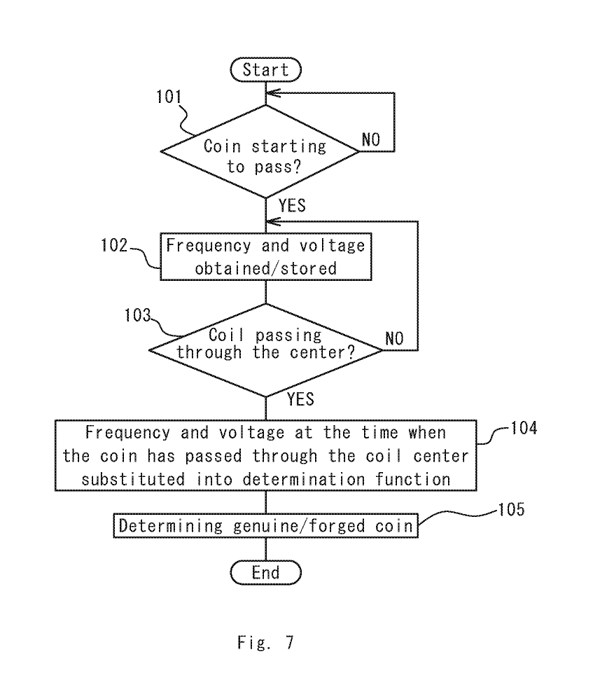

Next, it is explained how the coin processing device is operated. FIG. 7 shows the flow of operation of the coin processing device.

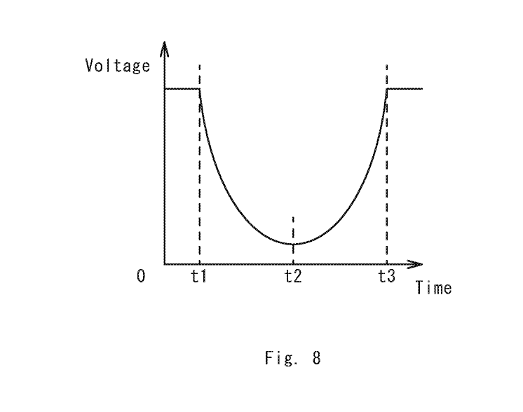

When the coin processing device starts its operation, it waits for the coin 1 to be thrown. When the coin 1 is thrown, rotatively moves in the coin passage 2 and reaches the vicinity of the identification sensor 3, the output (voltage and its frequency) of the identification sensor 3 changes. The voltage of the identification sensor 3 changes as shown in FIG. 8, for example, with t1 representing the time when the coin 1 has reached the vicinity of the identification sensor 3. It is noted that the identification sensor 3 detects the coin 1 between the time t1 and the time t3.

When the coin 1 begins to pass through the vicinity of the identification sensor 3 (YES in Step 101), CPU 6 obtains voltage by way of an envelope detection circuit 4, obtains frequency by way of a frequency detection circuit 5, and stores them in a memory not shown (Step 102).

The voltage and frequency are regularly obtained and stored (Step 102) until the coin 1 has passed through around the center of the identification sensor 3 (NO in Step 103). It is noted that the CPU 6 determines from the output of the identification sensor 3 whether or not the coin 1 has passed through around the center of the identification sensor 3. When the coin 1 has passed through around the center of the identification sensor 3, the voltage of the identification sensor 3 which has been decreasing begins to increase as the time t2 shows in FIG. 8, and thus, this output change is recognized as indicating that the coin 1 has passed through around the center of the identification sensor 3.

When the coin 1 has passed through around the center of the identification sensor 3 (YES in Step 103), the CPU 6 performs a calculation by substituting the voltage and frequency at the time when the coin 1 has passed through around the center of the identification sensor 3 into the predetermined determination function (Step 104), determines the genuineness of the passing coin 1 based on the calculation result (Step 105), and finishes the processing.

### Embodiment 2

In Embodiment 1, an explanation of how a coin is identified by the use of a pair of identification sensors 3 is shown, whereas in Embodiment 2, an explanation of how a coin is identified by the use of two pairs of identification sensors is shown.

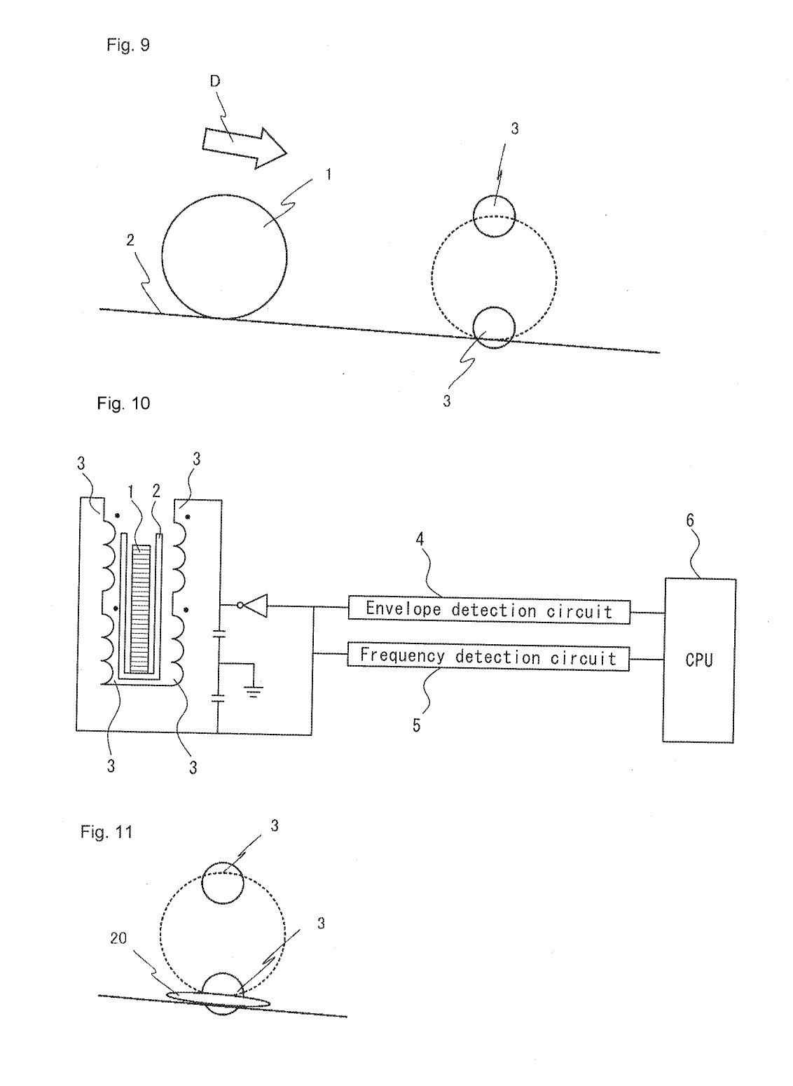

FIG. 9 shows an example of how the identification sensor in the coin processing device in Embodiment 2 in the present invention is arranged. As shown in FIG. 9, in the coin processing device in Embodiment 2, the identification sensor 3 is arranged in the coin passage 2 inclined so that the coin 1 rotatively moves in the direction of the arrow D in the drawing.

This identification sensor 3 is arranged in the lower part and the upper part in the coin passage 2, where the part of the layer in the coin 1 thickly plated due to the dock-bone effect passes through. The identification sensor 3 arranged in the upper part in the coin passage 2 is arranged in the part upper from the floor face of the coin passage 2 to the same extent as the diameter of the coin 1.

Also the identification sensor 3 comprises two pairs of coils and, as shown in FIG. 10, is connected to an oscillation circuit, obtains voltage from the oscillation circuit by way of an envelope detection circuit 4, obtains frequency by way of a frequency detection circuit 5, inputs the obtained voltage and frequency respectively to CPU 6, and uses determination function, in order to determine the genuineness of the coin.

It is noted that, for the coils constituting the identification sensor 3, a winding coil obtained by winding copper wire, etc. around a core or a printed coil obtained by spirally printing metal foil on a substrate can be used.

It is noted that the principle for determining coins and the operation of the coin processing device are not explained here, since they are the same as in Embodiment 1.

When two pairs of coils are used as the identification sensor 3 and connected in series as shown in this Embodiment 2, even if the dust 20, etc. is accumulated on the floor face of the coin passage 2 and the coin 1 passes through the position higher than the floor face of the coin passage 2 as shown in FIG. 11, the change of detection range of the identification sensor 3 arranged in the upper part and the change of detection range of the identification sensor 3 arranged in the lower part are offset, and thereby the genuineness of the coin 1 can be determined.

### Embodiment 3

In Embodiment 3, the identification sensor with a coil having a shape different from the shape of the coils used in Embodiment 1 and Embodiment 2 is explained.

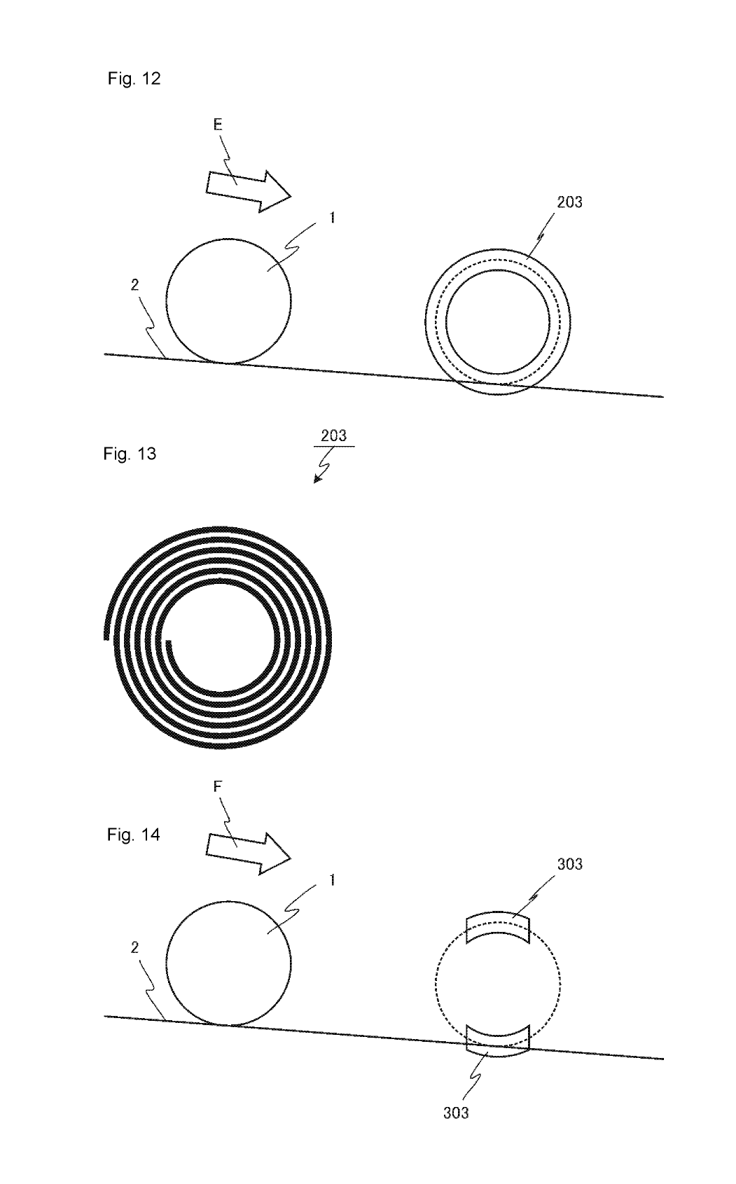

FIG. 12 shows an example of how the identification sensor in the coin processing device in Embodiment 3 in the present invention is arranged. As shown in FIG. 12, in the coin processing device in Embodiment 3, the identification sensor 203 is arranged in the coin passage 2 inclined so that the coin 1 rotatively moves in the direction of the arrow E in the drawing.

This identification sensor 203 is arranged in the coin passage 2 in the position where the part of the layer in the coin 1 thickly plated due to the dock-bone effect passes through, so that the above part can be entirely detected.

In addition, the above identification sensor 203 is an annular printed coil as shown in FIG. 13. Since this identification sensor 203 has no coil at the center, and a printed coil has smaller inductance and weaker magnetic field than a winding coil, the magnetic flux diffuses less from the center of the printed coil in comparison with the case of the winding coil. Thereby, the identification sensor 203 is free from any influence from the center of the coin, and the characteristics (voltage value and frequency value) of the edge of the coin can be obtained with high precision.

Furthermore, since the identification sensor 203 entirely detects the part of the layer in the coin 1 thickly plated due to the dock-bone effect, such a case as coin variance or accumulation of dust, etc. in the coin passage 2 would not inhibit the genuineness of the coin 1 from being determined with relatively high precision.

It is noted that the circuit configuration in the coin processing device in Embodiment 3 is the same as the circuit configuration (FIG. 5) in the coin processing device in Embodiment 1. Also, the principle for determining coins and the operation of the coin processing device are not explained here, since they are the same as in Embodiment 1.

### Embodiment 4

In Embodiment 4, the identification sensor with a coil having a shape different from the shape of the coils used in Embodiment 1, Embodiment 2 and Embodiment 3 is explained.

FIG. 14 shows an example of how the identification sensor in the coin processing device in Embodiment 4 in the present invention is arranged. As shown in FIG. 14, in the coin processing device in Embodiment 4, the identification sensor 303 is arranged in the coin passage 2 inclined so that the coin 1 rotatively moves in the direction of the arrow F in the drawing.

This identification sensor 203 is arranged in the lower part and the upper part in the coin passage 2, where the part of the layer in the coin 1 thickly plated due to the dock-bone effect passes through. The identification sensor 3 arranged in the upper part in the coin passage 2 is arranged in the part upper from the floor face of the coin passage 2 to the same extent as the diameter of the coin 1.

Also the identification sensor 303 comprises two pairs of coils, and a winding coil obtained by winding copper wire, etc. around a core or a printed coil obtained by spirally printing metal foil on a substrate can be used.

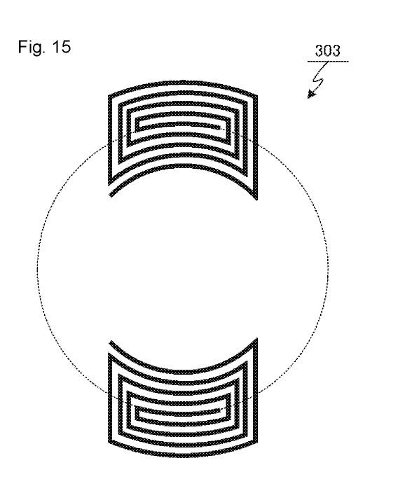

In the coils in this identification sensor 303, the parts in contact with the coin passage 2, namely the faces opposing the coin 1 are arc (bow)-shaped, as shown in FIG. 15, according to the diameter of the coin 1 to be detected.

In the configuration explained in Embodiment 4, the shape of the coils of the identification sensor 303 is more complicated than in Embodiment 2, but the coin can be determined with higher precision than in Embodiment 2.

It is noted that the circuit configuration in the coin processing device in Embodiment 4 is the same as the circuit configuration (FIG. 10) in the coin processing device in Embodiment 2. Also, the principle for determining coins and the operation of the coin processing device are not explained here, since they are the same as in Embodiment 1.

### DESCRIPTION OF THE REFERENCE NUMERALS

1 Coin
2 Coin passage
3 Identification sensor
4 Envelope detection circuit
5 Frequency detection circuit
6 CPU (Determination means)
7 Magnetic flux
8 Eddy current generating region
9 Eddy current generating region
11 Core material
12 Plated layer
13 Core material
14 Plated layer
203 Identification sensor
303 Identification sensor

1. A coin identification device which identifies a plated coin characterized by comprising
an identification sensor formed of coils arranged on a wall face of a coin passage in which the coin rotatively moves, in a position where a thickly plated part of layer of the coin passes through, and
determination means for determining coin genuineness by obtaining from output of the identification sensor characteristic data including characteristics of both of a plated layer and a core material of the coin.

2. The coin identification device claimed in claim 1 characterized in that the identification sensor is arranged on an upper part and a lower part of the wall face of the coin passage.

3. The coin identification device claimed in claim 2 characterized in that the identification sensor is arc-shaped according to diameter of the coin to be identified.

4. The coin identification device claimed in claim 1 characterized in that the identification sensor is annularly shaped with circumference according to the diameter of the coin to be identified.

5. The coin identification device claimed in claim 1 characterized in that the identification sensor comprises printed coils obtained by forming a spiral coil of metal foil on a substrate.
